(19) United States
(12) Patent Application Publication
(10) Pub. No.: US 2025/0181341 A1
(43) Pub. Date: Jun. 5, 2025

(54) FIRMWARE MANAGEMENT FOR UPDATING DIAGNOSTIC CAPABILITIES

(71) Applicant: Micron Technology, Inc., Boise, ID (US)

(72) Inventor: Marco Redaelli, Muenchen (DE)

(21) Appl. No.: 18/783,340

(22) Filed: Jul. 24, 2024

Related U.S. Application Data
(60) Provisional application No. 63/605,741, filed on Dec. 4, 2023.

(51) Int. Cl. G06F 8/65

(52) U.S. Cl. CPC G06F 8/65

(57) ABSTRACT

Methods, systems, and apparatuses include receiving, by a memory subsystem, an activate command for firmware of the memory subsystem, where the firmware includes a core firmware subportion and a diagnostic firmware subportion, content of the diagnostic firmware subportion differs from content of the core firmware subportion, and the diagnostic firmware subportion and the core firmware subportion execute independently of one another. The core firmware subportion is activated causing the memory subsystem to operate using the core firmware subportion in response to the received activate command. The diagnostic firmware subportion is deactivated preventing the memory subsystem from operating using the diagnostic firmware subportion in response to the received activate command.

### CROSS-REFERENCE TO RELATED APPLICATION

The present application claims the benefit of U.S. Provisional Patent Application No. 63/605,741 filed on Dec. 4, 2023, which is incorporated by reference herein in its entirety.

### TECHNICAL FIELD

The present disclosure generally relates to firmware management, and more specifically, relates to firmware management for updating diagnostic capabilities.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 illustrates another example computing system that includes a firmware management component in accordance with some embodiments of the present disclosure.

FIG. 3 is a flow diagram of an example method to manage firmware for updating diagnostic capabilities in accordance with some embodiments of the present disclosure.

FIG. 4 is another flow diagram of an example method to manage firmware for updating diagnostic capabilities in accordance with some embodiments of the present disclosure.

FIG. 5 is a block diagram of an example computer system in which embodiments of the present disclosure may operate.

### DETAILED DESCRIPTION

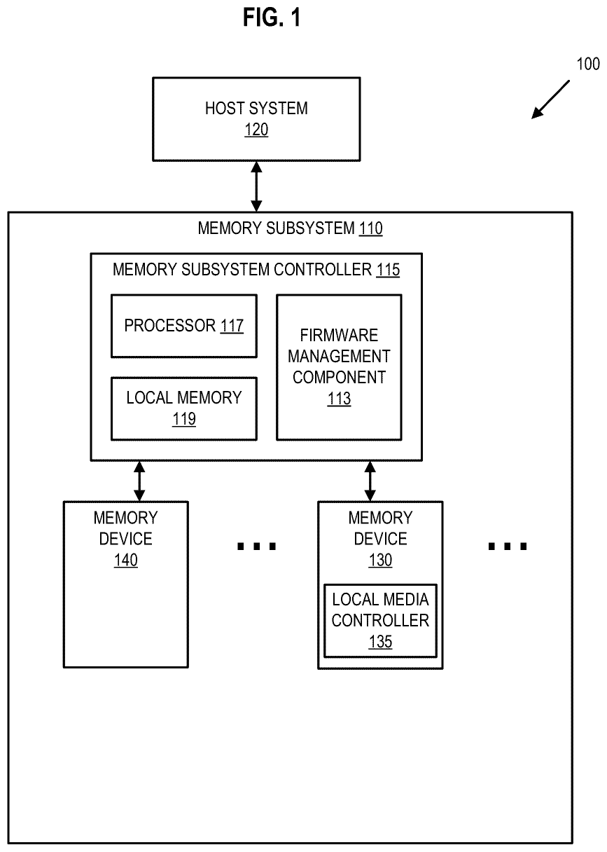

Aspects of the present disclosure are directed to managing firmware for updating diagnostic capabilities in a memory subsystem. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units identified by a logical unit number (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), quad-level cells (QLCs), and penta-level cells (PLCs). For example, an SLC can store one bit of information and has two logic states while a QLC can store four bits of information and has sixteen logic states.

In conventional memory systems, firmware for memory subsystems manages the functionality of memory devices in the memory subsystem and diagnoses aspects of the memory subsystem (e.g., providing a device field self-test). For ease of explanation, these are referred to respectively as core firmware functionality and diagnostic firmware functionality. These separate functionalities are included in a single, monolithic piece of production firmware. As a result, an update of the diagnostic firmware functionality results in an update of the entire firmware. In industries with memory system applications that are sensitive to updates, such as military, satellite, automotive, and others, testing and verifying the memory firmware is a time and cost intensive task. Due to the high cost of defective firmware in these industries (e.g., permanent loss of satellite connectivity or causing an automotive crash), any changes to memory firmware must undergo this costly and extensive process for firmware verification even if the changes are limited to changes to the diagnostic firmware, which runs in controlled environments (e.g., an automotive repair shop) and is therefore not associated with the elevated risks normally present in these applications.

Aspects of the present disclosure address the above and other deficiencies by partitioning the firmware into core firmware and diagnostic firmware. The memory subsystem stores the different firmware subportions in different firmware slots such that only one of the core firmware and diagnostic firmware can be active at a time. The diagnostic firmware can therefore be updated without incurring additional firmware verification costs or risking the reliability and safety of the core firmware.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processing device such as a processor chipset and a software stack executed by the processor chipset. The processor chipset can include one or more cores, one or more caches, a memory controller (e.g., NVDIMM controller), and/or a storage protocol controller (e.g., a peripheral component interconnect express (PCIe) controller, a serial advanced technology attachment (SATA) controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a SATA interface, including a mini-SATA (mSATA) interface, a PCIe interface, including a mini PCIe (mPCIE) interface, a Non-Volatile Memory Express (NVMe) interface, a universal serial bus (USB) interface, an a Fibre Channel, Serial Attached SCSI (SAS), a Small Computer System Interface (SCSI), a double data rate (DDR) memory bus, a dual in-line memory module (DIMM) interface (e.g., DIMM socket interface that supports Double Data Rate (DDR)), an Advanced Host Controller (AHCI) interface, an Open NAND Flash Interface (ONFI) interface, a Double Data Rate (DDR) interface, a Low Power Double Data Rate (LPDDR) interface, any other interface, and/or combinations of these interfaces. The physical host interface can be used to transmit data between the host system 120 and the memory subsystem 110. The host system 120 can further utilize an NVMe interface to access components (e.g., memory devices 130 and 140) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via the same communication connection, multiple separate communication connections, and/or a combination of communication connections.

The memory devices 130 and 140 can include any combination of the different types of non-volatile memory devices and/or volatile memory devices. The volatile memory devices (e.g., memory device 140) can be, but are not limited to, random-access memory (RAM), such as dynamic random-access memory (DRAM), synchronous dynamic random-access memory (SDRAM), video random-access memory (VRAM), and cache memory.

Some examples of non-volatile memory devices (e.g., memory device 130) include negative-and (NAND) type flash memory devices and write-in-place type memory devices, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), Spin Transfer Torque (STT)-MRAM, nano-RAM (NRAM), silicon-oxide-nitride-oxide-silicon (SONOS) memory, conductive bridging RAM (CBRAM), resistive random-access memory (RRAM), oxide based RRAM (OxRAM), negative-or (NOR) flash memory, and erasable programmable read-only memory (EPROM), including electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The buffer memory of subsystem controller 115 can include any of the volatile or non-volatile memory types mentioned above including combinations thereof. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in memory subsystem 110 (e.g., stored in a local memory 119). In some examples, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processing device or controller separate from the memory subsystem 110).

In general, the memory subsystem controller 115 can receive commands or operations from the host system 120 and can convert the commands or operations into instructions or appropriate commands to achieve the desired access to the memory devices (e.g., memory devices 130 and/or 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA) and/or namespace) and a physical address (e.g., physical block address) that are associated with the memory devices (e.g., memory devices 130 and/or 140). The memory subsystem controller 115 can further include host interface circuitry to communicate with the host system 120 via the physical host interface. The host interface circuitry can convert the commands received from the host system into command instructions to access the memory devices (e.g., memory devices 130 and/or 140) as well as convert responses associated with the memory devices into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices (e.g., memory devices 130 and/or 140).

In some embodiments, the memory devices (e.g., memory devices 130 and/or 140) include local media controllers 135 that operate in conjunction with memory subsystem controller 115 to execute operations on one or more memory cells of the memory devices (e.g., memory devices 130 and/or 140). An external controller (e.g., memory subsystem controller 115) can externally manage the memory devices (e.g., perform media management operations on the memory devices 130 and/or 140). In some embodiments, a memory device (e.g., memory device 130) is a managed memory device, which is a raw memory device combined with a local controller (e.g., local controller 135) for media management within the same memory device package. An example of a managed memory device is a managed NAND (MNAND) device.

The memory subsystem 110 includes a firmware management component 113 that manages firmware for updating diagnostic capabilities. In some embodiments, the controller 115 includes at least a portion of the firmware management component 113. For example, the controller 115 can include a processing device 117 configured to execute instructions stored in local memory 119 for performing the operations described herein. In some embodiments, a firmware management component 113 is part of the host system 120, an application, or an operating system.

The firmware management component 113 manages diagnostic capabilities by partitioning firmware for a memory subsystem into diagnostic firmware and core firmware. Further details with regards to the operations of the firmware management component 113 are described below.

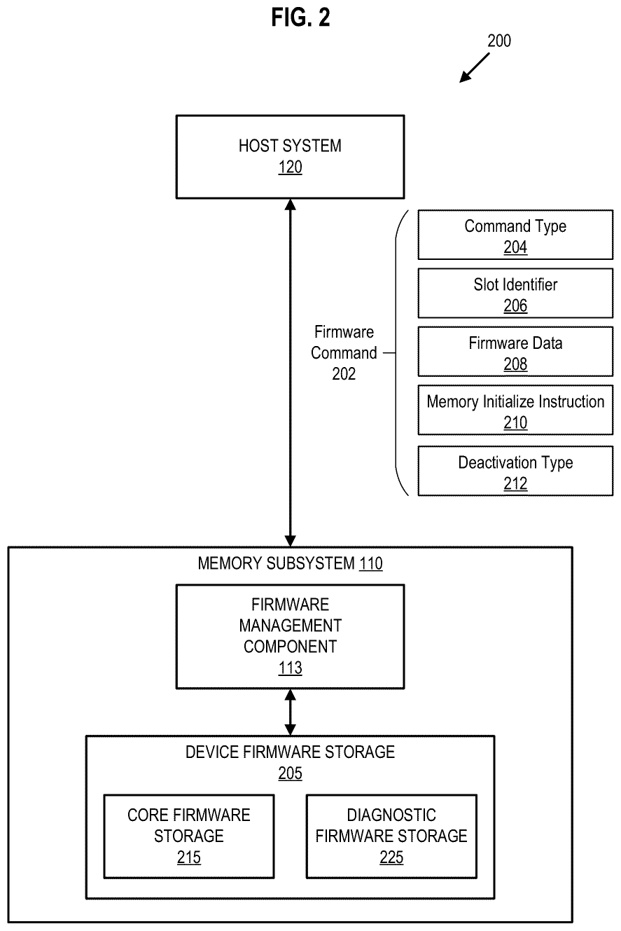

FIG. 2 illustrates another example computing system 200 that includes firmware management component 113 in accordance with some embodiments of the present disclosure. Example computing system 200 also includes host system 120, memory subsystem 110, and device firmware storage 205. As shown in FIG. 2, host system 120 is coupled to firmware management component 113 via memory subsystem 110. Firmware management component 113 is coupled to device firmware storage 205 and configured to download firmware to device firmware storage 205 and activate and deactivate firmware slots (e.g., core firmware storage 215 and diagnostic firmware storage 225) of device firmware storage 205. Device firmware storage 205 stores the firmware for memory subsystem 110. In some embodiments, device firmware storage 205 is incorporated within local memory of memory subsystem 110 (e.g., local memory 119 of FIG. 1).

As shown in FIG. 2, device firmware storage 205 includes core firmware storage 215 and diagnostic firmware storage 225 subportions. Core firmware storage 215 stores a firmware subportion that manages the functionality of memory devices (e.g., memory devices 130 and/or 140 of FIG. 1) in memory subsystem 110. For example, core firmware storage 215 includes firmware for executing functions to manage NAND devices. Diagnostic firmware storage 225 stores a firmware subportion that diagnoses and monitors aspects of memory subsystem 110. For example, diagnostic firmware storage 225 includes firmware for executing functions related to a device field self-test or built-in self-test. In some embodiments, executing the self-test functions causes memory subsystem 110 to test itself to enhance safety and reliability of memory subsystem 110 and reduce repair cycle times. In some embodiments, diagnostic firmware storage 225 and core firmware storage 215 execute independently of one another. For example, memory subsystem 110 can execute core firmware storage 215 or diagnostic firmware storage 225 but not both simultaneously.

The content of core firmware storage 215 differs from the content of diagnostic firmware storage 225. For example, core firmware storage 215 includes content related to managing the functionality of memory devices but does not include content for executing self-test functions and diagnostic firmware storage 225 includes content for executing self-test functions and does not include content related to managing the functionality of memory devices. In some embodiments, core firmware storage 215 and diagnostic firmware storage 225 are separate firmware slots of device firmware storage 205 and only one of the firmware slots can be activated at a given time. In some embodiments, although only two firmware slots are illustrated, device firmware storage 205 includes multiple firmware slots. In such embodiments, however, device firmware storage 205 only contains one diagnostic firmware storage 225. While device firmware storage 205 may use partitions and/or subdivisions other than firmware slots, for simplicity, the term firmware slot will be used when referring to partitions and/or subdivisions of device firmware storage 205.

As shown in FIG. 2, host system 120 sends firmware command 202 to memory subsystem 110. Firmware command 202 can include a command type 204, a slot identifier 206, firmware data 208, memory initialize instruction 210, and a deactivation type 212. Although illustrated as including command type 204, slot identifier 206, firmware data 208, memory initialize instruction 210, and deactivation type 212, firmware command 202 may only contain a subset of these. For example, firmware command 202 with an activate command type 204 may only include slot identifier 206.

In some embodiments, command type 204 is an activate command. For example, host system 120 sends firmware command 202 with activate command type 204 to memory subsystem 110. In such embodiments, memory subsystem 110 receives firmware command 202 and firmware management component 113 activates a firmware subportion of core firmware storage 215 or diagnostic firmware storage 225. For example, firmware command 202 includes a slot identifier 206 identifying a firmware slot of device firmware storage 205 to activate. In response to receiving firmware command 202 with activate command 204 and including slot identifier 206 identifying the firmware slot, firmware management component 113 activates the firmware stored in, e.g., core firmware storage 215. For example, firmware management component 113 activates core firmware storage 215 causing memory subsystem 110 to execute firmware stored in core firmware storage 215.

In some embodiments, in response to receiving firmware command 202 with activate command type 204, firmware management component 113 deactivates a firmware slot not identified by slot identifier 206. For example, host system 120 sends firmware command 202 to memory subsystem 110 with an activate command type 204 and slot identifier 206 identifying the firmware slot to activate. In response to memory subsystem 110 receiving firmware command 202, firmware management component 113 activates core firmware storage 215 and deactivates diagnostic firmware storage 225. For example, when firmware management component 113 deactivates diagnostic firmware storage 225, it prevents memory subsystem 110 from executing firmware stored in diagnostic firmware storage 225.

In some embodiments, firmware command 202 includes memory initialize instruction 210. For example, host system 120 sends firmware command 202 to memory subsystem 110 with an activate command type 204 and a memory initialize instruction 210. Memory subsystem 110 receives firmware command 202 with memory initialize instruction 210 causing firmware management component 113 to perform a warm start of the memory subsystem 110. In some embodiments, firmware command 202 is an activate command type 204 including slot identifier 206 and memory initialize instruction 210. For example, host system 120 sends firmware command 202 to memory subsystem 110 including memory initialize instruction 210 and a slot identifier 206 identifying diagnostic firmware storage 225. In response to receiving firmware command 202, memory subsystem 110 performs a warm start and re-initializes, executing the firmware in diagnostic firmware storage 225 after re-initialization.

In some embodiments, command type 204 is a download command. For example, host system 120 sends firmware command 202 with a download command type 204, slot identifier 206, and firmware data 208. A firmware command 202 with a download command type 204 is a firmware command for firmware management component 113 to save and/or store firmware data 208 in a firmware storage (e.g., core firmware storage 215 or diagnostic firmware storage 225). In response to receiving firmware command 202, firmware management component 113 downloads firmware data 208 into the firmware slot identified by slot identifier 206. In one embodiment, in response to receiving firmware command 202 with a download command type 204, firmware management component 113 updates the firmware stored in the firmware slot identified by slot identifier 206. For example, in response to receiving firmware command 202 with a download command type 204 and a slot identifier 206 identifying diagnostic firmware storage 225, firmware management component 113 updates the firmware in diagnostic firmware storage 225 using firmware data 208. Due to the separation using different firmware slots, firmware management component 113 does not update firmware in firmware slots not identified by slot identifier 206. For example, in response to receiving firmware command 202 including slot identifier 206 identifying the diagnostic firmware storage 225, firmware management component 113 does not update the firmware in core firmware storage 215. In some embodiments, download type firmware commands only download firmware data 208 and do not activate the firmware stored in the updated firmware storage (e.g., until receiving an activate command). In some embodiments, firmware management component 113 updates the firmware in core firmware storage 215 using firmware data 208.

In some embodiments, firmware command 202 includes a download command type 204 and an activate command type 204. In such embodiments, firmware command 202 includes a slot identifier 206 for each of the download command type 204 and the activate command type 204. For example, host system 120 sends firmware command 202 including both a download and an activate command type 204 with the slot identifier for the download command identifying the diagnostic firmware storage 225 and the slot identifier for the activate command identifying the core firmware storage 215. In response to memory subsystem 110 receiving firmware command 202, firmware management component 113 downloads firmware data 208 into diagnostic firmware storage 225 and activates core firmware storage 215.

In some embodiments, in response to activating core firmware storage 215, firmware management component 113 deactivates diagnostic firmware storage 225. For example, firmware management component 113 downloads firmware data 208 into diagnostic firmware storage 225 and causing memory subsystem 110 to execute firmware stored in core firmware storage 215, preventing memory subsystem 110 from executing firmware stored in diagnostic firmware storage 225.

In some embodiments, command type 204 is a deactivate command. For example, host system 120 sends firmware command 202 with a deactivate command type 204 and a slot identifier 206 identifying core firmware storage 215. In response to memory subsystem 110 receiving firmware command 202, firmware management component 113 deactivates core firmware storage 215, preventing memory subsystem 110 from executing firmware stored in core firmware storage 215. In some embodiments, in response to memory subsystem 110 receiving firmware command 202 with a deactivate command type 204 and slot identifier 206, firmware management component 113 activates firmware in a slot not identified by slot identifier 206. For example, in response to receiving firmware command 202 with a deactivate command type 204 and slot identifier 206 identifying diagnostic firmware storage 225, firmware management component 113 activates diagnostic firmware storage 225.

In some embodiments, firmware command 202 is a deactivate command type 204 and includes deactivation type 212. For example, deactivation type 212 includes a temporary deactivation type, a password protected deactivation type, and/or a permanent deactivation type. For example, host system 120 sends firmware command 202 with a deactivate command type 204, a slot identifier 206 identifying diagnostic firmware storage 225, and a temporary deactivation type 212. In response to memory subsystem 110 receiving firmware command 202, firmware management component 113 deactivates diagnostic firmware storage 225 for a set period or until a certain condition is met.

In response to memory subsystem 110 receiving firmware command 202 with a deactivate command type 204, a slot identifier 206 identifying diagnostic firmware storage 225, and a temporary deactivation type 212, firmware management component 113 deactivates diagnostic firmware storage 225, preventing memory subsystem 110 from executing the firmware stored in diagnostic firmware storage 225 until memory subsystem 110 is power cycled (e.g., until memory subsystem 110 is powered down and then powered back up again). In some embodiments, host system 120 sends firmware command 202 with a deactivate command type 204 and a temporary deactivation type 212 upon powering on memory subsystem 110.

In some embodiments, deactivation type 212 includes a password protected deactivation type. For example, host system 120 sends firmware command 202 with a deactivate command type 204, a slot identifier 206 identifying diagnostic firmware storage 225, a password protected deactivation type 212, and a deactivate password. In response to memory subsystem 110 receiving firmware command 202, firmware management component 113 deactivates diagnostic firmware storage 225 if the deactivate password is correct. For example, firmware management component 113 compares the received deactivate password to a stored password (e.g., stored in a local memory). In response to receiving firmware command 202 and verifying that the deactivate password provided is correct, firmware management component 113 deactivates diagnostic firmware storage 225.

In some embodiments, a firmware slot deactivated by a deactivate command with a password protected deactivation type can only be reactivated by an activate command with the correct password. For example, in response to memory subsystem 110 receiving firmware command 202 with an activate command type 204, slot identifier 206 identifying the deactivated firmware slot, and an activate password, firmware management component 113 compares the activate password to the correct password. If the activate password is correct, firmware management component 113 reactivates the firmware slot identified by slot identifier 206.

In some embodiments, deactivation type 212 is a permanent deactivation type. For example, host system 120 sends firmware command 202 with a deactivate command type 204, a slot identifier 206 identifying diagnostic firmware storage 225, and a permanent deactivation type 212. In response to memory subsystem 110 receiving firmware command 202, firmware management component 113 permanently deactivates diagnostic firmware storage 225. For example, firmware management component 113 permanently deactivates diagnostic firmware storage 225, permanently preventing the memory subsystem from executing firmware stored in diagnostic firmware storage 225.

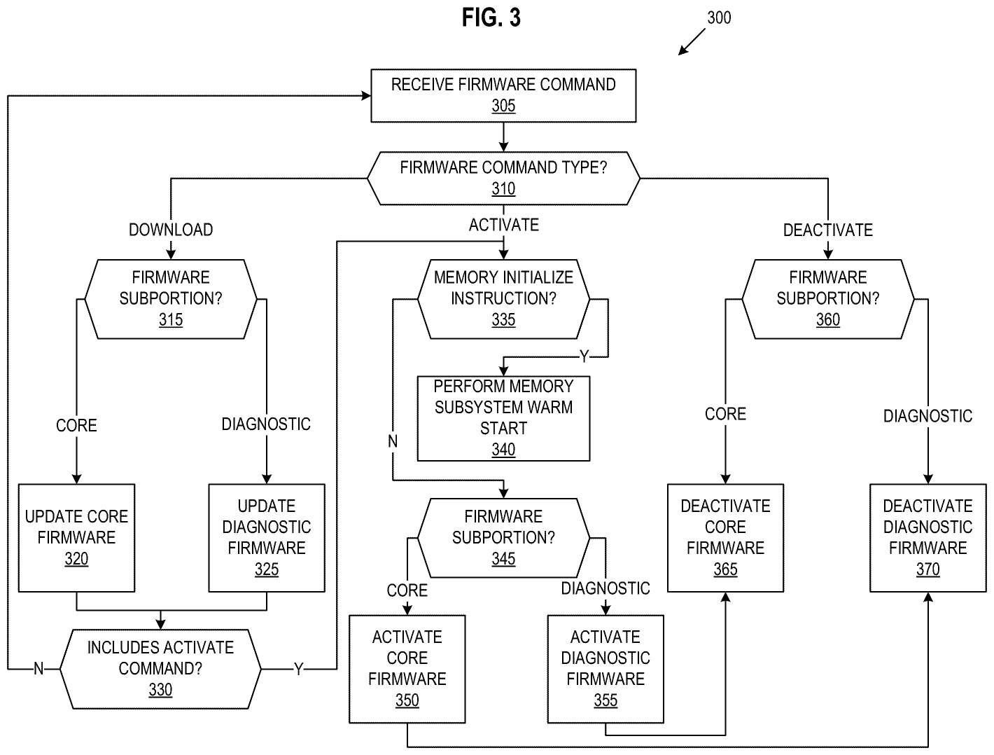

FIG. 3 is a flow diagram of an example method 300 to manage firmware for updating diagnostic capabilities, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the firmware management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device receives a firmware command. For example, firmware management component 113 receives firmware command 202 from host system 120. In some embodiments, firmware command 202 includes one or more of command type 204, slot identifier 206, firmware data 208, memory initialize instruction 210, and/or deactivation type 212.

At operation 310, the processing device determines the firmware command type. For example, firmware management component 113 determines the command type 204 of received firmware command 202. If the processing device determines that the command type is download, the method 300 proceeds to operation 315. If the processing device determines that the command type is activate, the method 300 proceeds to operation 335. If the processing device determines that the command type is deactivate, the method 300 proceeds to operation 360.

At operation 315, the processing device determines the firmware subportion identified in the received download command. For example, firmware management component 113 determines whether slot identifier 206 of firmware command 202 identifies a firmware slot for core firmware storage 215 or a firmware slot for diagnostic firmware storage 225. If the processing device determines that the firmware subportion identified is the core firmware subportion, the method 300 proceeds to operation 320. If the processing device determines that the firmware subportion identified is the diagnostic firmware subportion, the method 300 proceeds to operation 325.

At operation 320, the processing device updates the core firmware. For example, firmware management component 113 downloads firmware data 208 received in firmware command 202 to core firmware storage 215.

At operation 325, the processing device updates the diagnostic firmware. For example, firmware management component 113 downloads firmware data 208 received in firmware command 202 to diagnostic firmware storage 225.

At operation 330, the processing device determines whether the received download command includes an activate command. For example, firmware management component 113 determines whether firmware command 202 includes both a download and activate command type 204. If the processing device determines that the received download command includes an activate command, the method 300 proceeds to operation 335. If the processing device determines that the received download command does not include an activate command, the method 300 returns to operation 305 and waits for the next firmware command.

At operation 335, the processing device determines whether the activate command includes a memory initialize instruction. For example, firmware management component 113 determines whether firmware command 202 includes memory initialize instruction 210. If the processing device determines that the activate command includes a memory initialize instruction, the method 300 proceeds to operation 340. If the processing device does not determine that the activate command includes a memory initialize instruction, the method 300 proceeds to operation 345.

At operation 340, the processing device performs a warm start of the memory subsystem. For example, memory subsystem 110 performs a warm start and reinitializes.

At operation 345, the processing device determines the firmware subportion identified in the activate command. For example, firmware management component 113 determines whether slot identifier 206 of firmware command 202 identifies a firmware slot for core firmware storage 215 or diagnostic firmware storage 225. If the processing device determines that the firmware subportion identified is the core firmware subportion, the method 300 proceeds to operation 350. If the processing device determines that the firmware subportion identified is the diagnostic firmware subportion, the method 300 proceeds to operation 355.

At operation 350, the processing device activates the core firmware. For example, firmware management component 113 causes memory subsystem 110 to execute the firmware stored in core firmware storage 215. In some embodiments, the processing device does not activate the core firmware if the core firmware has been deactivated. For example, firmware management component 113 does not activate core firmware storage 215 if core firmware storage 215 has been deactivated by a deactivate command with a permanent deactivation type. Further details with regard to deactivation types are explained with reference to FIG. 2.

At operation 355, the processing device activates the diagnostic firmware. For example, firmware management component 113 causes memory subsystem 110 to execute the firmware stored in diagnostic firmware storage 225. In some embodiments, the processing device does not activate the diagnostic firmware if the diagnostic firmware has been deactivated. For example, firmware management component 113 does not activate diagnostic firmware storage 225 if diagnostic firmware storage 225 has been deactivated by a deactivate command with a permanent deactivation type. Further details with regard to deactivation types are explained with reference to FIG. 2.

At operation 360, the processing device determines the firmware subportion identified in the received deactivate command. For example, firmware management component 113 determines whether slot identifier 206 of firmware command 202 identifies a firmware slot for core firmware storage 215 or diagnostic firmware storage 225. If the processing device determines that the firmware subportion identified is the core firmware subportion, the method 300 proceeds to operation 365. If the processing device determines that the firmware subportion identified is the diagnostic firmware subportion, the method 300 proceeds to operation 370.

At operation 365, the processing device deactivates the core firmware. For example, firmware management component 113 prevents memory subsystem 110 from executing the firmware stored in core firmware storage 215. In some embodiments, the processing device deactivates the core firmware using a deactivation type. For example, firmware management component 113 permanently deactivates core firmware storage 215 if deactivation type 212 of firmware command 202 is permanent. In some embodiments, in response to the processing device activating diagnostic firmware (e.g., operation 355), the method 300 proceeds to operation 365 and deactivates the core firmware. Further details with regard to deactivation types are explained with reference to FIG. 2.

At operation 370, the processing device deactivates the diagnostic firmware. For example, firmware management component 113 prevents memory subsystem 110 from executing the firmware stored in diagnostic firmware storage 225. In some embodiments, the processing device deactivates the diagnostic firmware using a deactivation type. For example, firmware management component 113 permanently deactivates diagnostic firmware storage 225 if deactivation type 212 of firmware command 202 is permanent. In some embodiments, in response to the processing device activating core firmware (e.g., operation 350), the method 300 proceeds to operation 370 and deactivates the diagnostic firmware. Further details with regard to deactivation types are explained with reference to FIG. 2.

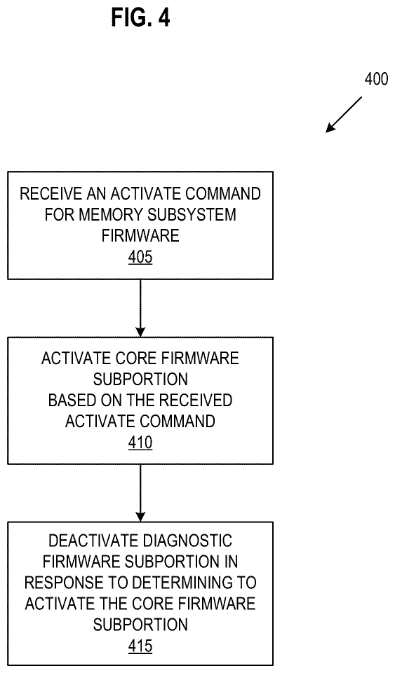

FIG. 4 is another flow diagram of an example method 400 to manage firmware for updating diagnostic capabilities, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the firmware management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device receives an activate command for memory subsystem firmware. For example, memory subsystem 110 receives firmware command 202 with an activate command type 204 from host system 120. In some embodiments, the activate command includes a slot identifier. For example, firmware command 202 includes slot identifier 206 identifying the firmware slot to activate. In some embodiments, the activate command includes a memory initialize instruction. For example, firmware command 202 includes memory initialize instruction 210 causing memory subsystem 110 to perform a warm start using the firmware slot identified by slot identifier 206 upon re-initializing. In some embodiments, the activate command includes a download command. Further details with regard to receiving an activate command are described with reference to FIG. 2.

At operation 410, the processing device activates the core firmware subportion based on the received activate command. For example, firmware management component 113 determines that slot identifier 206 identifies core firmware storage 215 and activates core firmware storage 215 causing memory subsystem 110 to execute firmware stored in core firmware storage 215. In some embodiments with both an activate command and a download command, the activate command includes a slot identifier for a firmware slot to activate and the download command includes a slot identifier for a firmware slot to store the downloaded firmware. For example, firmware command 202 includes an activate command type 204 and a download command type 204. In response to memory subsystem 110 receiving firmware command 202, firmware management component 113 downloads firmware data 208 of firmware command 202 into the firmware slot identified by the slot identifier of the download command type 204 and activates the firmware slot identified by the activate command type. In some embodiments, firmware management component 113 causes memory subsystem 110 to perform a warm start and execute firmware stored in core firmware storage 215 upon memory subsystem 110 performing the warm start. Further details with regard to activating the core firmware subportion are described with reference to FIG. 2.

At operation 415, the processing device deactivates the diagnostic firmware subportion in response to determining to activate the core firmware subportion. For example, firmware management component 113 prevents memory subsystem 110 from executing firmware stored in diagnostic firmware storage 225. Further details with regard to deactivating the diagnostic firmware subportion are described with reference to FIG. 2.

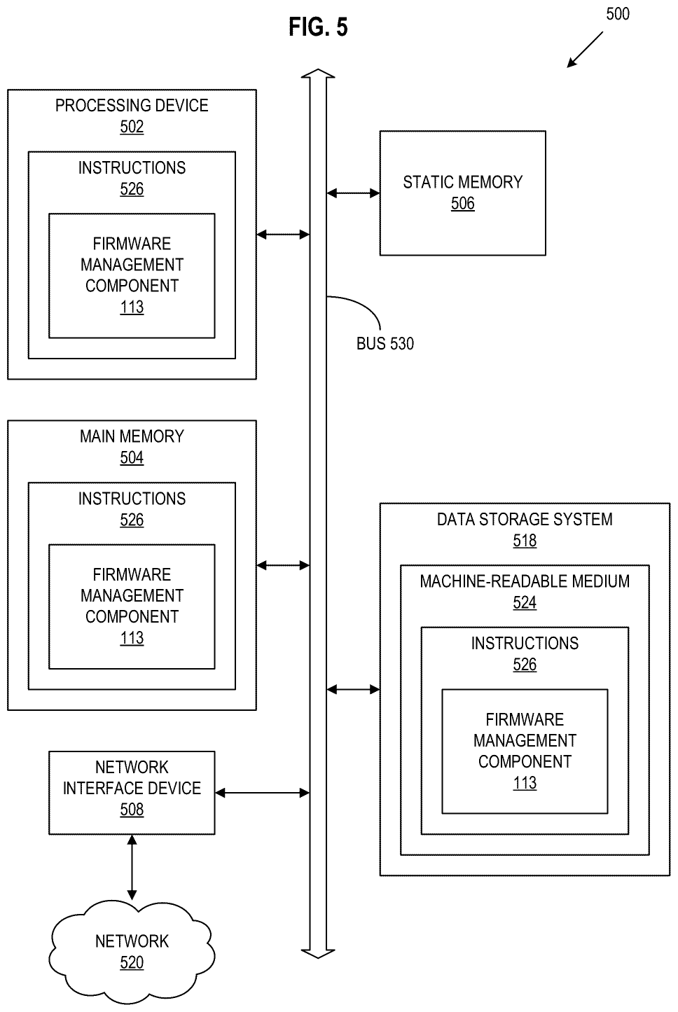

FIG. 5 illustrates an example machine of a computer system 500 within which a set of instructions for causing the machine to perform any one or more of the methodologies discussed herein can be executed. In some embodiments, the computer system 500 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the firmware management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a smart device, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random-access memory (DRAM) such as synchronous DRAM (SDRAM) or Rambus DRAM (RDRAM), etc.), a static memory 506 (e.g., flash memory, static random-access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526, constituting machine-readable storage media, can also reside, completely or at least partially, within the main memory 504 and/or within the processing device 502 during execution thereof by the computer system 500, the main memory 504 and the processing device 502. The machine-readable storage medium 524, data storage system 518, and/or main memory 504 can correspond to the memory subsystem 10 of FIG. 1.

In one embodiment, the instructions 526 include instructions to implement functionality corresponding to a firmware management component (e.g., firmware management component 113 of FIG. 1). While the machine-readable storage medium 524 is shown in an example embodiment to be a single medium, the term “machine-readable storage medium” should be taken to include a single medium or multiple media that store the one or more sets of instructions (e.g., instructions 526). The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 300 and 400 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMs, EEPROMs, magnetic or optical cards, or any type of media suitable for storing electronic instructions coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, by a memory subsystem, an activate command for firmware of the memory subsystem, wherein the firmware comprises a core firmware subportion and a diagnostic firmware subportion, content of the diagnostic firmware subportion differs from content of the core firmware subportion, and the diagnostic firmware subportion and the core firmware subportion execute independently of one another;
activating the core firmware subportion to cause the memory subsystem to operate using the core firmware subportion in response to the received activate command; and
deactivating the diagnostic firmware subportion to prevent the memory subsystem from operating using the diagnostic firmware subportion in response to the received activate command.

2. The method of claim 1, further comprising:
receiving, by the memory subsystem, a download command for the firmware; and
updating the diagnostic firmware subportion based on the download command, wherein the update of the diagnostic firmware subportion does not update the core firmware subportion.

3. The method of claim 2, wherein the download command includes the activate command and wherein activating the core firmware subportion is in response to receiving the download command.

4. The method of claim 1, wherein the activate command comprises a memory initialize instruction, and wherein activating the core firmware subportion comprises:
performing a warm start of the memory subsystem to cause the memory subsystem to operate using the core firmware subportion in response to the warm start.

5. The method of claim 1, wherein the memory subsystem includes a plurality of firmware slots and wherein the core firmware subportion and the diagnostic firmware subportion are stored in different firmware slots of the plurality of firmware slots.

6. The method of claim 1, further comprising:
receiving, by the memory subsystem, a deactivate command for the firmware; and
deactivating the diagnostic firmware subportion based on the deactivate command, wherein the deactivation prevents the memory subsystem from using the diagnostic firmware subportion.

7. The method of claim 6, wherein the deactivate command comprises a deactivation type and wherein deactivating the core firmware subportion uses the deactivation type, the method further comprising:
receiving, by the memory subsystem, a second activate command for the core firmware subportion; and
determining to reactivate the diagnostic firmware subportion based on the deactivation type.

8. A non-transitory computer-readable storage medium comprising instructions that, when executed by a processing device, cause the processing device to:
receive, by a memory subsystem, an activate command for firmware of the memory subsystem, wherein the firmware comprises a core firmware subportion and a diagnostic firmware subportion, content of the diagnostic firmware subportion differs from content of the core firmware subportion, and the diagnostic firmware subportion and the core firmware subportion execute independently of one another;
activate the core firmware subportion to cause the memory subsystem to operate using the core firmware subportion in response to the received activate command; and
deactivate the diagnostic firmware subportion to prevent the memory subsystem from operating using the diagnostic firmware subportion in response to the received activate command.

9. The non-transitory computer-readable storage medium of claim 8, wherein the processing device is further to:
receive, by the memory subsystem, a download command for the firmware; and
update the diagnostic firmware subportion based on the download command, wherein the update of the diagnostic firmware subportion does not update the core firmware subportion.

10. The non-transitory computer-readable storage medium of claim 9, wherein the download command includes the activate command and wherein activating the core firmware subportion is in response to receiving the download command.

11. The non-transitory computer-readable storage medium of claim 8, wherein the activate command comprises a memory initialize instruction, and wherein activating the core firmware subportion comprises:
performing a warm start of the memory subsystem to cause the memory subsystem to operate using the core firmware subportion in response to the warm start.

12. The non-transitory computer-readable storage medium of claim 8, wherein the memory subsystem includes a plurality of firmware slots and wherein the core firmware subportion and the diagnostic firmware subportion are stored in different firmware slots of the plurality of firmware slots.

13. The non-transitory computer-readable storage medium of claim 8, wherein the processing device is further to:
receive, by the memory subsystem, a deactivate command for the firmware; and
deactivate the diagnostic firmware subportion based on the deactivate command, wherein the deactivation prevents the memory subsystem from using the diagnostic firmware subportion.

14. The non-transitory computer-readable storage medium of claim 13, wherein the deactivate command comprises a deactivation type, wherein deactivating the core firmware subportion uses the deactivation type, and wherein the processing device is further to:
receive, by the memory subsystem, a second activate command for the core firmware subportion; and
determine to reactivate the diagnostic firmware subportion based on the deactivation type.

15. A system comprising:
a plurality of memory devices; and
a processing device, operatively coupled with the plurality of memory devices, to:
receive, by a memory subsystem, an activate command and a download command for firmware of the memory subsystem, wherein the firmware comprises a core firmware subportion and a diagnostic firmware subportion, content of the diagnostic firmware subportion differs from content of the core firmware subportion, and the diagnostic firmware subportion and the core firmware subportion execute independently of one another;
update the diagnostic firmware subportion based on the download command, wherein the update of the diagnostic firmware subportion does not update the core firmware subportion;
activate the core firmware subportion to cause the memory subsystem to operate using the core firmware subportion in response to the received activate command; and
deactivate the diagnostic firmware subportion to prevent the memory subsystem from operating using the diagnostic firmware subportion in response to the received activate command.

16. The system of claim 15, wherein the download command includes the activate command and wherein activating the core firmware subportion is in response to receiving the download command.

17. The system of claim 15, wherein the activate command comprises a memory initialize instruction, and wherein activating the core firmware subportion comprises:
performing a warm start of the memory subsystem to cause the memory subsystem to operate using the core firmware subportion in response to the warm start.

18. The system of claim 15, wherein the memory subsystem includes a plurality of firmware slots and wherein the core firmware subportion and the diagnostic firmware subportion are stored in different firmware slots of the plurality of firmware slots.

19. The system of claim 15, wherein the processing device is further to:
receive, by the memory subsystem, a deactivate command for the firmware; and
deactivate the diagnostic firmware subportion based on the deactivate command, wherein the deactivation prevents the memory subsystem from using the diagnostic firmware subportion.

20. The system of claim 19, wherein the deactivate command comprises a deactivation type, wherein deactivating the core firmware subportion uses the deactivation type, and wherein the processing device is further to:
receive, by the memory subsystem, a second activate command for the core firmware subportion; and
determine to reactivate the diagnostic firmware subportion based on the deactivation type.
